(19) United States
(12) Patent Application Publication
(10) Pub. No.: US 2009/0060232 A1
(43) Pub. Date: Mar. 5, 2009

(54) Condenser microphone

(75) Inventors: Seiji Hirade, Fukuroi-shi (JP); Tamito Suzuki, Fukuroi-shi (JP); Masayoshi Omura, Hamamatsu-shi (JP); Yuusaku Ebihara, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 12/221,573

(22) Filed: Aug. 5, 2008

(30) Foreign Application Priority Data
Aug. 8, 2007 (JP) 2007-206462

(51) Int. Cl. H04R 25/00

(52) U.S. Cl. 381/174

(57) ABSTRACT

A condenser microphone includes a substrate having an opening in a back cavity, a diaphragm including a center portion and a plurality of arms extended in the radial direction from the center portion, a plate positioned opposite the diaphragm, and a support structure for supporting the periphery of the diaphragm and the periphery of the plate above the substrate while insulating the diaphragm and the plate both having conductive properties from each other. The support structure forms gaps between the substrate, the diaphragm, and the plate. Projections having insulating properties are formed in the center portion and the arms of the diaphragm so as to project towards the substrate and are separated from each other in the circumferential direction of the diaphragm. This prevents the diaphragm from being unexpectedly adhered and fixed to the substrate, thus improving the sensitivity of the condenser microphone.

### BACKGROUND OF THE INVENTION

1. Field of the Invention

The present invention relates to condenser microphones serving as micro-electro-mechanical-system (MEMS) microphones.

The present application claims priority on Japanese Patent Application No. 2007-206462, the content of which is incorporated herein by reference.

2. Description of the Related Art

Conventionally, various types of miniature silicon condenser microphones have been manufactured by way of semiconductor device manufacturing processes. They are disclosed in various documents such as Patent Document 1, Patent Document 2, Patent Document 3, and Non-Patent Document 1.

Patent Document 1: Japanese Patent Application Publication No. H09-508777

Patent Document 2: Japanese Patent Application Publication No. 2004-506394

Patent Document 3: U.S. Pat. No. 4,776,019

Non-Patent Document 1: MSS-01-34 published by Japanese Institute of Electrical Engineers

The aforementioned condenser microphones are known as MEMS microphones, each of which includes a diaphragm and a plate corresponding to thin films deposited on a substrate, wherein the diaphragm and the plate are distanced from each other and are supported above the substrate. The diaphragm vibrates due to sound pressure so as to serve as a moving electrode, which is positioned opposite the plate serving as a fixed electrode, so that a parallel-plate condenser is formed by the diaphragm and the plate. When the diaphragm vibrates due to sound waves, electrostatic capacitance of the condenser varies due to the displacement thereof. Variations of electrostatic capacitance are converted into electric signals.

When sound waves propagate into a back cavity (which is partitioned by the diaphragm) via a gap formed between the diaphragm and the plate, they may propagate along both sides of the diaphragm, thus resulting in a degradation of the sensitivity of the condenser microphone. When the back cavity is completely closed by the diaphragm, it becomes very difficult to establish a balance between the internal pressure of the back cavity and the atmospheric pressure. This may cause unexpected damage to the diaphragm, or make the sensitivity of the condenser microphone unstable. For this reason, it is very important to make the height of a gap between the substrate and the diaphragm as low as possible and to thereby increase an acoustic resistance of the gap.

When the height of a gap between the substrate and the diaphragm is reduced, there is a possibility that the diaphragm applied with a high wind pressure or a high impact may easily come into contact with the substrate. In this case, the diaphragm may be unexpectedly adhered or fixed to the substrate; hence, the conventionally-known condenser microphones suffer from a reduction of the rated value of the maximum sound pressure and a weakness against impact.

The sensitivity of the condenser microphone can be improved by increasing the ratio of the displacement of the diaphragm relative to the distance between the moving electrode and the fixed electrode (which are positioned opposite each other), by improving the vibration characteristics of the diaphragm, and by reducing the parasitic capacitance (which does not contribute to variations of electrostatic capacitance of the condenser).

### SUMMARY OF THE INVENTION

It is an object of the present invention to provide a miniature condenser microphone having improved sensitivity.

A condenser microphone of the present invention includes a substrate having an opening in a back cavity, a diaphragm which is composed of a deposited film having a conductive property and which includes a center portion positioned opposite to the opening and its surrounding area of the substrate and a plurality of arms extended in radial directions from the center portion, a plate which is composed of a deposited film having a conductive property and which is positioned opposite to the diaphragm, and a support structure for supporting a periphery of the diaphragm and a periphery of the plate above the substrate while insulating the diaphragm and the plate from each other. The support structure composed of a deposited film forms a first gap between the substrate and the diaphragm and a second gap between the diaphragm and the plate. In addition, a plurality of projections projecting towards the substrate is formed in the center portion of the diaphragm in a circumferential direction between the arms.

In the above, the diaphragm has a gear-like shape in plan view, which includes the center portion and the arms extended from the center portion in radial directions. This improves vibration characteristics of the diaphragm based on sound waves. Herein, sound waves may propagate via the cutouts between the arms of the diaphragm so as to enter the backside space of the diaphragm (which is opposite the plate). Sound waves propagating towards the backside of the diaphragm degrade the sensitivity of the condenser microphone. In the region in which the diaphragm is positioned opposite the substrate, sound waves propagating towards the backside of the diaphragm are damped highly as the acoustic resistance of the gap between the diaphragm and the substrate becomes higher. This acoustic resistance highly depends upon the width of the region (i.e. the length of the diaphragm in the radial direction), the height of the region (i.e. the distance between the diaphragm and the substrate), and the widths of the arms (i.e. the circumferential length of the diaphragm in the circumferential direction). The width of the region is reduced in the cutout between the arms adjoining in the circumferential direction of the center portion of the diaphragm. That is, the acoustic resistance can be increased by increasing the widths of the arms, in other words, by reducing the widths of the cutouts formed between the adjacent arms. In contrast, vibration characteristics of the diaphragm can be improved by reducing the widths of the arms, in other words, by increasing the widths of the cutouts formed between the adjacent arms. For this reason, the condenser microphone of the present invention is characterized in that the projections (projecting towards the substrate) are formed in the cutouts between the arms in the circumferential direction of the center portion of the diaphragm. This reduces the height of the region (in which the diaphragm is positioned opposite to the substrate) in the center portion of the diaphragm due to the formation of the projections. That is, the present invention is designed to prevent the acoustic resistance from decreasing in the cutouts between the adjacent arms in the circumferential direction of the center portion of the diaphragm even when the cutouts are formed in the diaphragm, so as to improve vibration characteristics. This makes it possible to control acoustic resistance (which isolates the back cavity from the gap between the diaphragm and the plate in audio characteristics) based on the height of a gap between the projection of the diaphragm and the substrate. When a relatively low height is applied to the gap between the projection of the diaphragm and the substrate, the diaphragm may easily come into contact with the substrate. In this case, the contact area between the diaphragm and the substrate is limited. As the contact area between the diaphragm and the substrate becomes small, it becomes difficult for the diaphragm to become adhered and fixed to the substrate even when the diaphragm accidentally comes into contact with the substrate. In short, the present invention provides a miniature condenser microphone having an improved sensitivity in which the height of the gap between the projection of the diaphragm and the substrate is designed to be small.

The projections can be composed of insulating materials, which avoids a short-circuit occurring between the diaphragm and the substrate.

In the condenser microphone, the diaphragm is composed of the deposited film having a conductive property, and the plate is composed of the deposited film having a conductive property. In addition, the distance between the center and the peripheral end of the plate is shorter than the distance between the center of the center portion and the distal end of the arm of the diaphragm. Herein, no parasitic capacitance occurs in the cutouts formed between the adjacent arms of the diaphragm at which the diaphragm is not positioned opposite the plate; hence, it is possible to reduce the overall value of the parasitic capacitance in the condenser microphone. Since both the diaphragm and the plate are formed using conductive deposited films, it is unnecessary to introduce a complex step of manufacturing in which a conductive film used for the formation of electrodes joins a prescribed part of an insulating film; hence, it is possible to simplify the manufacturing process.

In addition, the projections are formed in both the center portion and the arms of the diaphragm, wherein the projections formed in the center portion are positioned alternately with the projections formed in the arms in the radial direction. The projections of the arms are formed to traverse across the arms. The opposite ends of each projection formed in the center portion are positioned opposite the projections formed in the adjacent arms in the radial direction.

As described above, the projections of the center portion are separated from each other and are positioned apart from each other with prescribed distances (or non-projection lengths) therebetween. As the non-projection lengths between the projections of the center portion are increased, it is possible to reduce the possibility in which the projections of the center portion of the diaphragm may be adhered and fixed to the substrate in comparison with another structure in which a ring-shaped projection is formed in the center portion of the diaphragm. In addition, the opposite ends of each projection formed in the center portion of the diaphragm are positioned opposite the distal ends of the projections formed in the arms. This guides sound waves (which may initially propagate towards the back cavity via the cutouts between the arms of the diaphragm) to propagate in the narrow space formed between the projections of the center portion and the projections of the arms in the circumferential direction. The acoustic resistance may be slightly reduced due to the divided alignment of the projections; however, it is possible to suppress a reduction of the acoustic resistance by reducing the width of the space between the projections of the center portion and the projections of the arms in the radial direction of the diaphragm even when the non-projection lengths between the projections of the center portion are increased.

It is preferable that the projections of the arms be formed using waves of the diaphragm in the radial direction. The waves of the diaphragm in the radial direction make it easier for the diaphragm to vibrate due to sound waves. This further improves the sensitivity of the condenser microphone.

It is preferable that numerous holes be formed in the arms of the diaphragm. The holes reduce the rigidities of the arms, which in turn makes it easier for the diaphragm to vibrate due to sound waves. Thus, it is possible to further improve the sensitivity of the condenser microphone.

It is preferable that a plurality of arms be formed and positioned opposite the cutouts formed between the adjacent arms of the diaphragm. Since the arms of the plate are alternately arranged with and are not positioned opposite the arms of the diaphragm, it is possible to remarkably reduce the parasitic capacitance at the fixed end of the diaphragm. Thus, it is possible to further improve the sensitivity of the condenser microphone.

In this connection, the support structure includes a plurality of first supports, each having an insulating property, for supporting the periphery of the diaphragm above the substrate and a plurality of second supports, each having an insulating property, for supporting the periphery of the plate above the substrate. Each of the first and second supports includes an upper insulating portion and a lower insulating portion as well as a guard electrode sandwiched between the upper insulating portion and the lower insulating portion.

### BRIEF DESCRIPTION OF THE DRAWINGS

These and other objects, aspects, and embodiments of the present invention will be described in more detail with reference to the following drawings.

FIG. 1 is a plan view showing a MEMS structure of a condenser microphone including a plate, a diaphragm, and a substrate in accordance with a preferred embodiment of the present invention.

FIG. 2A is a sectional view taken along line 2A-2A in FIG. 1.

FIG. 2B is a sectional view taken along line 2B-2B in FIG. 1.

FIG. 2C is an enlarged view of a section 2C encompassed by a circle in FIG. 2A.

FIG. 3A is a circuit diagram showing an equivalent circuit of the condenser microphone without including a guard electrode in connection with the plate and the substrate.

FIG. 3B is a circuit diagram showing an equivalent circuit of the condenser microphone including the guard electrode.

FIG. 4 is a sectional view used for explaining a first step of a manufacturing method of the condenser microphone.

FIG. 5 is a sectional view used for explaining a second step of the manufacturing method of the condenser microphone.

FIG. 6 is a sectional view used for explaining a third step of the manufacturing method of the condenser microphone.

FIG. 7 is a sectional view used for explaining a fourth step of the manufacturing method of the condenser microphone.

FIG. 8 is a sectional view used for explaining a fifth step of the manufacturing method of the condenser microphone.

FIG. 9 is a sectional view used for explaining a sixth step of the manufacturing method of the condenser microphone.

FIG. 10 is a sectional view used for explaining a seventh step of the manufacturing method of the condenser microphone.

FIG. 11 is a sectional view used for explaining an eighth step of the manufacturing method of the condenser microphone.

FIG. 12 is a sectional view used for explaining a ninth step of the manufacturing method of the condenser microphone.

FIG. 13 is a sectional view used for explaining a tenth step of the manufacturing method of the condenser microphone.

FIG. 14 is a sectional view used for explaining an eleventh step of the manufacturing method of the condenser microphone.

FIG. 15 is a sectional view used for explaining a twelfth step of the manufacturing method of the condenser microphone.

FIG. 16 is a sectional view used for explaining a thirteenth step of the manufacturing method of the condenser microphone.

FIG. 17 is a sectional view showing a first variation of the condenser microphone.

FIG. 18A is a plan view showing a second variation of the condenser microphone.

FIG. 18B is a perspective view of the condenser microphone shown in FIG. 18A.

FIG. 18C is a sectional view showing the structure of the condenser microphone shown in FIG. 18A.

FIG. 19A is a plan view showing a third variation of the condenser microphone.

FIG. 19B is a perspective view of the condenser microphone shown in FIG. 19A.

FIG. 19C is a sectional view showing the structure of the condenser microphone shown in FIG. 19A.

FIG. 20A is a plan view showing a fourth variation of the condenser microphone.

FIG. 20B is a perspective view of the condenser microphone shown in FIG. 20A.

FIG. 20C is a sectional view showing the structure of the condenser microphone shown in FIG. 20A.

FIG. 21A is a plan view showing a fifth variation of the condenser microphone.

FIG. 21B is a sectional view showing the structure of the condenser microphone shown in FIG. 21A.

FIG. 21C is a sectional view showing the structure of the condenser microphone shown in FIG. 21A.

### DESCRIPTION OF THE PREFERRED EMBODIMENT

The present invention will be described in further detail by way of examples with reference to the accompanying drawings.

### 1. Constitution

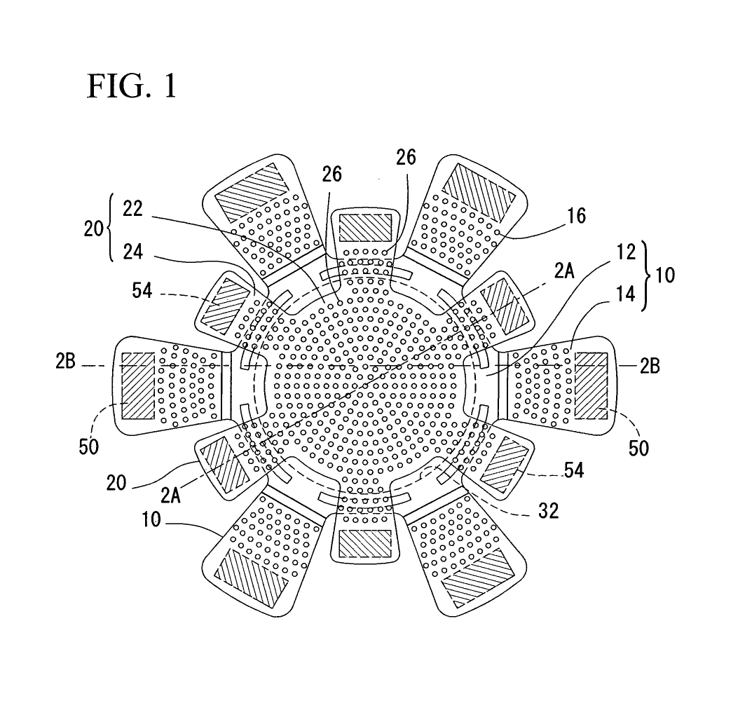

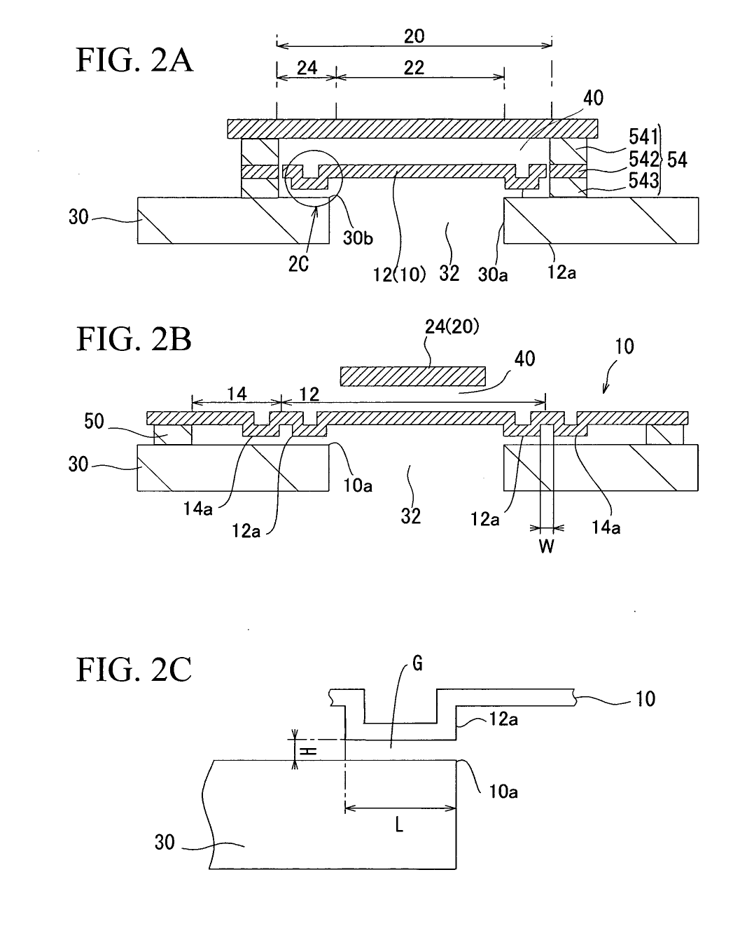

FIG. 1 is a plan view showing a MEMS structure of a condenser microphone in accordance with a preferred embodiment of the present invention. FIG. 2A is a sectional view taken along line 2A-2A in FIG. 1; and FIG. 2B is a sectional view taken along line 2B-2B in FIG. 1.

The condenser microphone of the present embodiment includes a diaphragm 10 and a plate 20 (which form a parallel-plate condenser), a substrate 30, a plurality of first supports 50 (for supporting the diaphragm 10 above the substrate 30), and a plurality of second supports 54 (for supporting the plate 20 above the substrate 30).

The substrate 30 is a monocrystal silicon substrate whose thickness ranges from 500 μm to 600 μm, for example. A through-hole 30a forming a side wall of a back cavity 32 is formed to run through the substrate 30. An opening 30b of the through-hole 30a leads the back cavity 32 to an atmospheric-pressure space. The opening 30b of the back cavity 32 is positioned substantially below a center portion 12 of the diaphragm 10. The back cavity 32 is closed by a package (not shown); hence, it communicates with the atmospheric-pressure space via gaps between the substrate 30 and the diaphragm 10. The back cavity 32 functions as a pressure chamber for buffering pressure variations applied to the diaphragm 10 from the substrate 30.

The diaphragm 10 is a single-layered conductive deposited film composed of polysilicon doped with impurities such as phosphorus (P). It may be possible to form the diaphragm in a multi-layered structure including a conductive film and an insulating film. The present embodiment simplifies the manufacturing process by forming the diaphragm 10 in a single-layered structure. The external periphery of the diaphragm 10 is supported above the substrate 30 by means of the first supports 50 having pillar shapes and insulating properties. The first supports 50 are composed of silicon oxide films, for example. The diaphragm 10 has a gear-like shape in plan view, wherein it is constituted of the center portion 12 (having a disk-like shape which is positioned opposite the opening 30b of the back cavity 32 and its surrounding area) and a plurality of arms 14 (which are extended in radial directions from the periphery of the center portion 12). Compared with other examples of diaphragms having circular outlines and rectangular outlines (not shown), the diaphragm 10 having a gear-like shape is reduced in elastic modulus in a radial direction. Numerous holes 16 are formed in the arms 14 so as to further reduce the elastic modulus of the diaphragm 10 in the radial direction. The diaphragm 10 of the present embodiment has prescribed dimensions, i.e., 0.5 μm thickness, 0.5 mm radius, 0.35 mm radius of the center portion 12, and 0.15 mm length of the arm 14.

A plurality of projections 12a and 14a which project downwardly towards the substrate 30 is formed on the prescribed area of the backside of the diaphragm 10 positioned opposite the substrate 30. Specifically, the projections 14a are formed on the backsides of the arms 14, while the projections 12a are formed on the backside of the center portion 12. Both the projections 12a and 14a are positioned to vertically match the surrounding area of the opening 30b of the back cavity 32, thus reducing the height of a gap between the diaphragm 10 and the substrate 30 (see a height H in FIG. 2C) in the surrounding area of the opening 30b of the back cavity 32. The gap between the diaphragm 10 and the substrate 30 is closely related to the acoustic resistance that may disturb propagation of sound waves in the back cavity 32. The acoustic resistance applied to the back cavity 32 is expressed in the form of a frequency-related function.

When the diaphragm 10 having a planar backside (not having the projections 12a and 14a) is positioned opposite the substrate 30 having a planar surface, it is necessary to reduce the height of the diaphragm 10 in its overall area above the substrate 30, thus reducing the acoustic resistance applied to the back cavity 32. However, this makes it easier for the diaphragm 10 to be adhered or fixed to the substrate 30 when the diaphragm 10 unexpectedly comes in contact with the substrate 30. Due to the formation of the projections 12a and 14a, it is possible to partially reduce the height of the gap between the diaphragm 10 and the substrate 30 while preventing the diaphragm 10 from being adhered or fixed to the substrate 30. This increases the acoustic resistance applied to the back cavity 32. With respect to sound waves propagating in a radial direction of the diaphragm 10 (in a direction from the center to the periphery), it is possible to increase the acoustic resistance applied to the back cavity 32 by reducing the height H between the projections 12a and 14a and the substrate 30 and by increasing a length L of the projection 12a or 14a in the radial direction of the diaphragm 10.

As shown in FIG. 1, the projections 12a are formed in the center portion 12 of the diaphragm 10 in such a way that they are aligned between the arms 14 in the circumferential direction and are divided in the circumferential direction with non-projection lengths substantially corresponding to the widths of the arms 14 therebetween. Such an alignment of the projections 12a allows the diaphragm 10 not to be easily adhered and fixed to the substrate 30. In the non-projection lengths in which no projection 12a is formed in the center portion 12, it is preferable to increase the acoustic resistance applied to the back cavity 32 by means of the projections 14a of the arms 14. That is, it is preferable that the opposite ends of each projection 12a be positioned opposite the adjacent projections 14a of the arms 14 in the radial direction. In order to increase the acoustic resistance between the projections 12a and the projections 14a in the circumferential direction, it is preferable that the distance W (see FIG. 2B) between the projections 12a and 14a be reduced as small as possible.

As shown in FIG. 2B, the projections 14a of the arms 14 are formed by way of waviness of the diaphragm 10 in the radial direction. When waviness of the diaphragm 10 in the radial direction traverses the arms 14 at which stress is concentrated, the elastic modulus of the diaphragm 10 in the radial direction is further reduced.

The plate 20 is a single-layered conductive deposited film composed of polysilicon doped with impurities such as phosphorus (P). It is possible to form the plate 20 in a multi-layered structure including a conductive film and an insulating film. The present embodiment simplifies the manufacturing process because the plate 20 is formed in a single-layered structure. The periphery of the plate 20 is supported above the substrate 30 by means of the second supports 54 each having an insulating property. The plate 20 is positioned opposite the diaphragm 10. A gap 40 whose height is approximately 4 μm is formed between the plate 20 and the diaphragm 10. The second supports 54 vertically connect the plate 20 and the substrate 30 together in the prescribed areas corresponding to the cutouts formed between the arms 14 of the diaphragm 10 in plan view. That is, the distance between the center and the peripheral end of the plate 20 is shorter than the distance between the center and the peripheral end of the diaphragm 10. This structure makes it very difficult for the plate 20 to vibrate.

The plate 20 has a gear-like shape including a center portion 22 (whose center substantially matches the center of the center portion 12 of the diaphragm 10 and whose diameter is smaller than the diameter of the center portion 12 of the diaphragm 10) and a plurality of arms 24 which are extended in radial directions from the center portion 22. The arms 24 of the plate 20 are positioned in correspondence with the cutouts formed between the arms 14 of the diaphragm 10. In other words, the arms 14 of the diaphragm 10 are positioned in correspondence with the cutouts formed between the arms 24 of the plate 20. This structure reduces the overall opposite area, in which the diaphragm 10 and the plate 20 are positioned opposite each other, in proximity to the fixed end of the diaphragm 10; hence, it is possible to reduce the parasitic capacitance of the condenser microphone. As shown in FIG. 1, numerous holes 26 are consecutively formed in the center portion 22 and the arms 24 of the plate 20. The holes 26 serve as sound holes, which allow sound waves (which enter into a package, not shown) to propagate through the plate 20 and to reach the diaphragm 10. The plate 20 is designed with prescribed dimensions, i.e., 1.5 μm thickness, 0.3 mm radius of the center portion 22, and 0.1 mm length of each arm 24.

As shown in FIG. 2A, each of the second supports 54 is constituted of an upper insulating portion 541, a guard electrode 542, and a lower insulating portion 543, wherein the guard electrode 542 is sandwiched between the upper insulating portion 541 and the lower insulating portion 543. The diaphragm 10 is insulated from the plate 20 by means of the upper insulating portion 541 and the lower insulating portion 543. Both the upper insulating film 541 and the lower insulating portion 543 are formed using a silicon oxide film, for example. In order to form the guard electrode 542 simultaneously with the diaphragm 10, it is preferable that the guard electrode 542 be composed of the same material as the diaphragm 10. The guard electrode 542 is set to the same potential as the plate 20 or the substrate 30. The guard electrode 542 is inserted between the upper insulating portion 541 and the lower insulating portion 543 so as to reduce the parasitic capacitance of the condenser microphone. In this connection, it is possible to omit the guard electrode 542 from the second support 54.

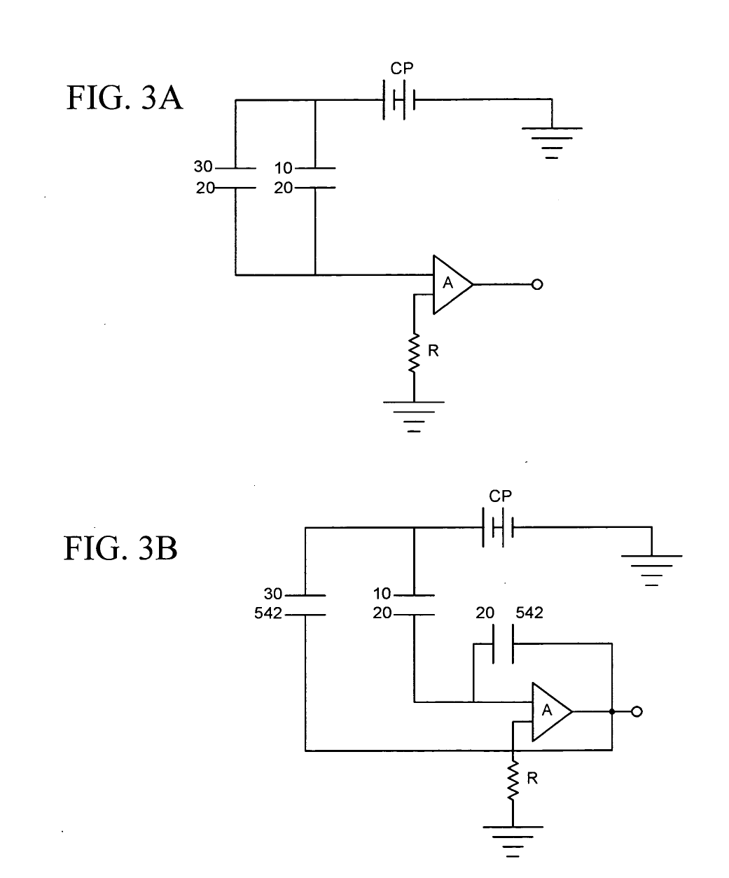

FIGS. 3A and 3B are circuit diagrams, each of which is used to explain the operation of the circuitry for detecting variations of electrostatic capacitance (between the diaphragm 10 and the plate 20) in the form of electric signals.

A charge pump CP applies a bias voltage to the diaphragm 10 in a stable manner. A voltage corresponding to variations of electrostatic capacitance between the diaphragm 10 and the plate 20 is supplied to a pre-amplifier A. Since the diaphragm 10 is short-circuited with the substrate 30, a parasitic capacitance occurs between the plate 20 and the substrate 30 in the circuitry of FIG. 3A which does not include the guard electrode 542.

In the circuitry of FIG. 3B which includes the guard electrode 542, the output terminal of the pre-amplifier A is connected to the guard electrode 542 so as to form a voltage follower using the pre-amplifier A, thus activating the guard electrode 542. That is, the voltage follower controls the plate 20 and the guard electrode 542 to be set to the same potential; thus, it is possible to remove the parasitic capacitance between the plate 20 and the guard electrode 542. Since the diaphragm 10 is short-circuited with the substrate 30, the capacitance between the guard electrode 542 and the substrate 30 becomes irrelevant to the output of the pre-amplifier A. Due to the provision of the guard electrode 542, it is possible to further reduce the parasitic capacitance of the condenser microphone.

The charge pump CP and the pre-amplifier A can be arranged in another die provided independently of a die having the MEMS structure; alternatively, they can be arranged in the die having the MEMS structure.

### 2. Manufacturing Method

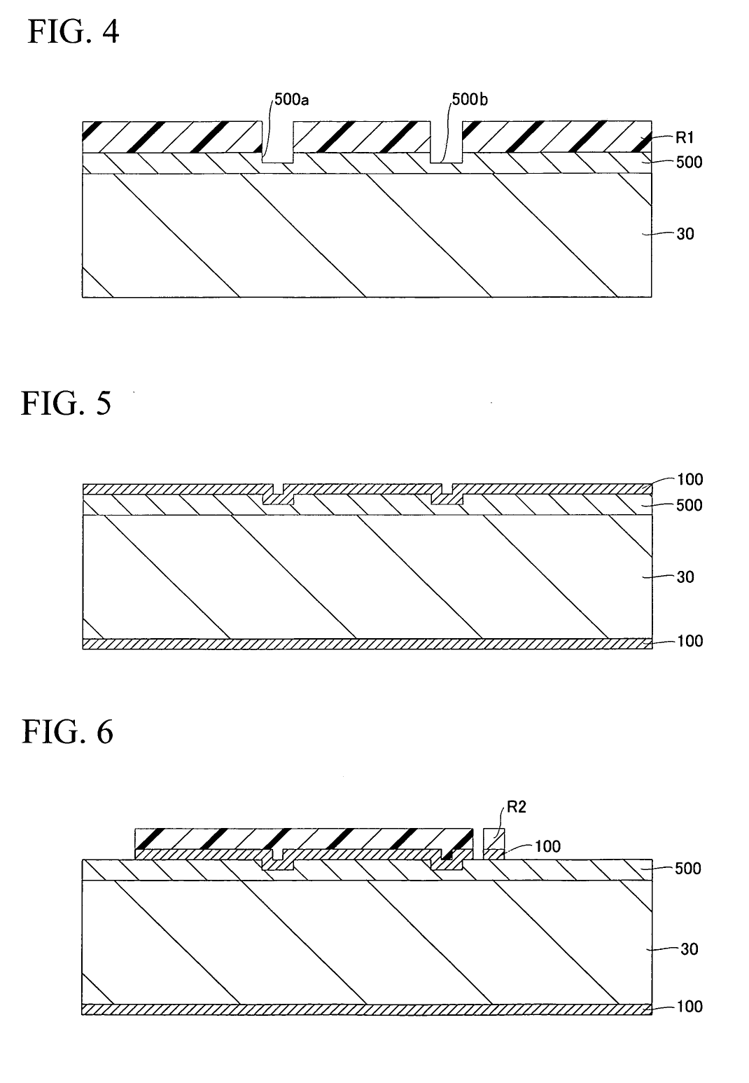

Next, a manufacturing method of the condenser microphone of the present embodiment will be described in detail with reference to FIGS. 4 to 16.

In a first step of the manufacturing method shown in FIG. 4, a first insulating film 500 having recesses 500a and 500b (which correspond to the projections 12a and 14a) is formed on the surface of the substrate 300 (which is a monocrystal silicon substrate, for example). The first insulating film 500 is a silicon oxide film of 2 μm thickness, which is formed by way of plasma chemical vapor deposition (i.e., plasma CVD). The recesses 500a and 500b are formed in the first insulating film 500 by way of photolithography and etching. Specifically, the recesses 500a and 500b are formed by way of etching using a photoresist mask R1 (which is applied onto the overall surface of the first insulating film 500 and is then subjected to patterning). The first insulating film 500 serves as a sacrificial film, which is used to form a gap between the diaphragm 10 and the substrate 30. It is also used for the formation of the first supports 50 for supporting the diaphragm 10 above the substrate 30, for the formation of the second supports 54 for supporting the plate 20 above the substrate 30, and for the formation of the lower insulating portion 543.

In a second step of the manufacturing method shown in FIG. 5, a first conductive film 100 (used for the formation of the diaphragm 10 and the guard electrode 542) is deposited on the surface of the first insulating film 500. As a result, the recesses 500a and 500b cause waves on the first conductive film 100, thus forming the projections 12a and 14a. The first conductive film 100 is formed by way of decompression CVD at 0.5 μm thickness and is composed of polysilicon doped with phosphorus (P). The first conductive film 100 is also deposited on the backside of the substrate 30.

In a third step of the manufacturing method shown in FIG. 6, anisotropic etching such as reactive ion etching (RIE) is performed using a photoresist mask R2 so as to selectively etch the first conductive film 100, which is thus processed in a prescribed shape. As a result, it is possible to form the diaphragm 10 at 0.5 μm thickness, the through-hole 16, the guard electrode 542, and an extension wire 13 (see FIG. 16). For the sake of convenience, the extension wire 13 is not shown in FIG. 1. Then, the photoresist mask R2 is removed.

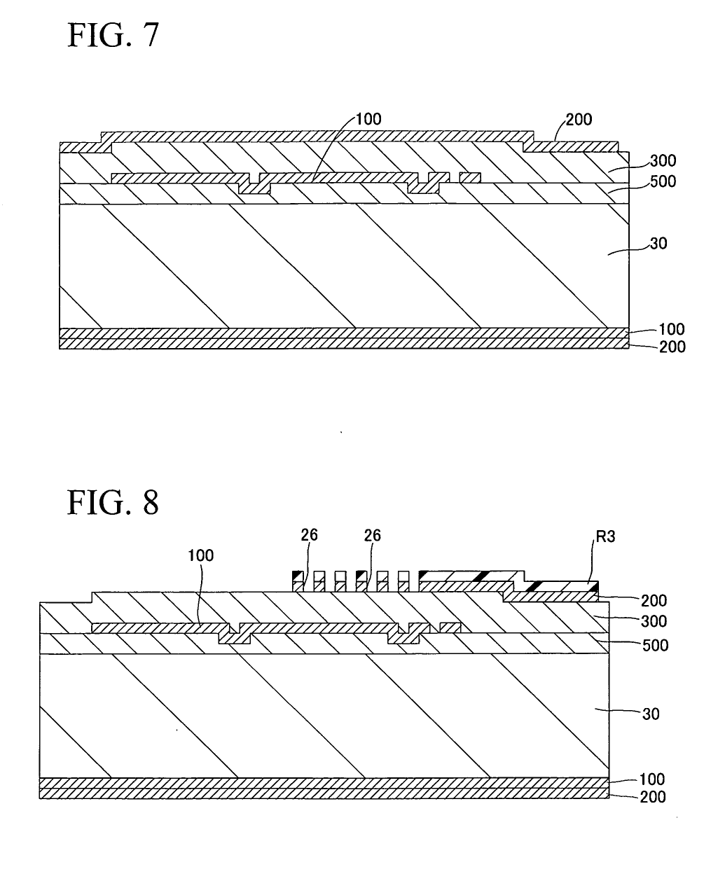

In a fourth step of the manufacturing method shown in FIG. 7, a second insulating film 300 and a second conductive film 200 are sequentially deposited on the surfaces of the first insulating film 500 and the first conductive film 100. The second insulating film 300 is a silicon oxide film of 4 μm thickness which is formed by way of plasma CVD, for example. The second insulating film 300 serves as a sacrificial film used for the formation of a gap between the diaphragm 10 and the plate 20, wherein it is also used for the formation of the upper insulating portions 541 of the second supports 54. The second conductive film 200 is a polysilicon film of 1.5 μm thickness doped with phosphorous (P), which is formed by way of decompression CVD. The second conductive film 200 is also deposited on the backside of the substrate 300.

In a fifth step of the manufacturing method shown in FIG. 8, anisotropic etching such as RIE is performed using a photoresist mask R3 so as to selectively etch the second conductive film 200, which is thus processed in a prescribed shape. As a result, it is possible to form the plate 20 at 1.5 μm thickness, the through-hole 26, and the extension wire 23 as shown in FIG. 16. For the sake of convenience, FIG. 1 does not show the extension wire 23. Then, the photoresist mask R3 is removed.

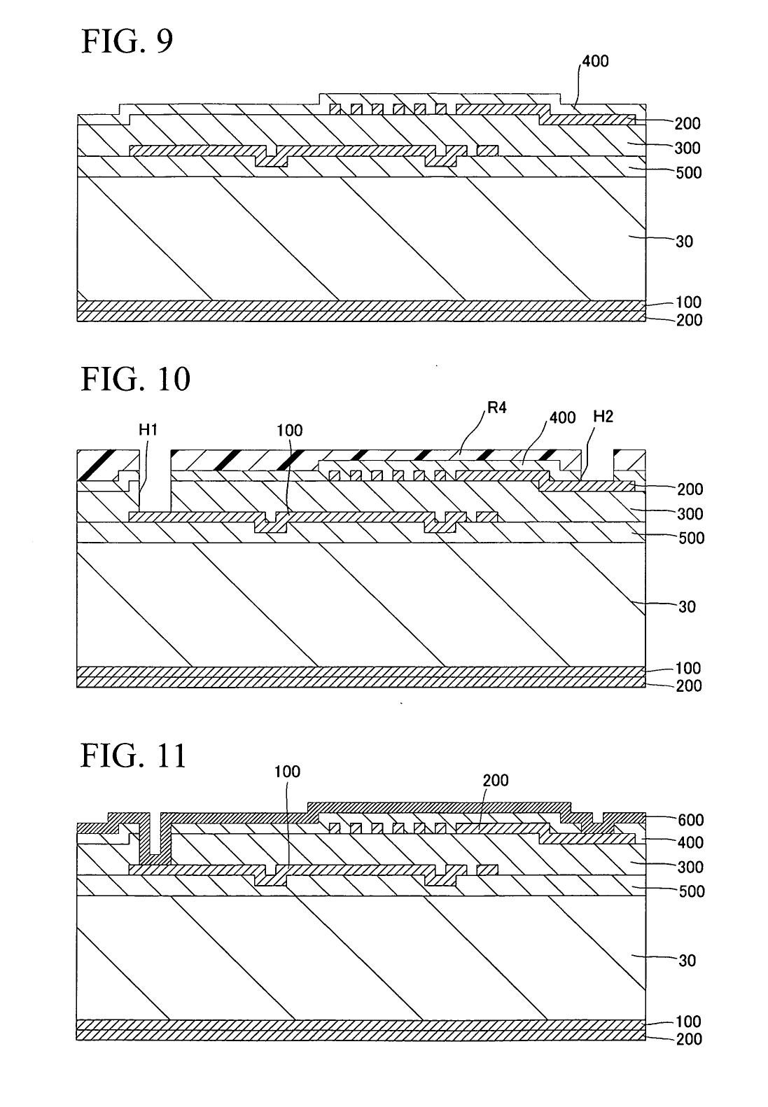

In a sixth step of the manufacturing method shown in FIG. 9, a third insulating film 400 is formed on the surfaces of the second insulating film 300 and the second conductive film 200. The third insulating film 400 is a silicon oxide film of 0.3 μm thickness which is formed by way of plasma CVD, for example.

In a seventh step of the manufacturing method shown in FIG. 10, etching is performed using a photoresist mask R4 so as to selectively etch the third insulating film 400 and the second insulating film 300, thus forming an electrode extraction hole H1 (for exposing the extension wire 13 of the diaphragm 10) and an electrode extraction hole H2 (for exposing the extension wire 23 of the plate 20). Then, the photoresist mask R4 is removed.

In an eighth step of the manufacturing method shown in FIG. 11, a third conductive film 600 is deposited to cover the surface of the first conductive film 100 exposed in the electrode extraction hole H1 and the surface of the second conductive film 200 exposed in the electrode extraction hole H2 as well as the surface of the third insulating film 400. The third conductive film 600 is composed of Al—Si and is formed by way of sputtering, for example.

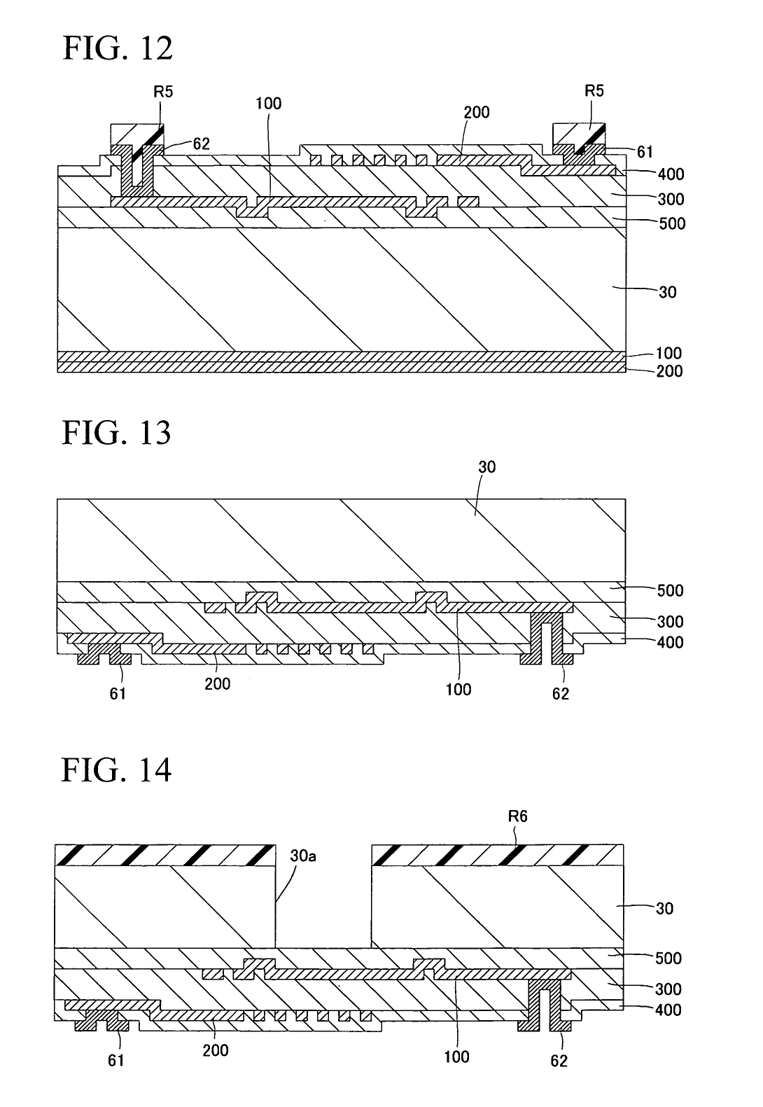

In a ninth step of the manufacturing method shown in FIG. 12, wet etching using a mixed acid is performed using a photoresist mask R5 so as to selectively etch the third conductive film 600, which is thus processed in a prescribed shape. As a result, it is possible to form a first electrode 62 (connected to the extension wire 13 of the diaphragm 10) and a second electrode 61 (connected to the extension wire 23 of the plate 20). Then, the photoresist mask R5 is removed.

In a tenth step of the manufacturing method shown in FIG. 13, the second conductive film 200 and the first conductive film 100 deposited on the backside of the substrate 30 are polished and removed. Then, the backside of the substrate 30 is further polished so as to adjust the thickness of the substrate 300 ranging from 500 μm to 600 μm.

In an eleventh step of the manufacturing method shown in FIG. 14, anisotropic etching such as deep RIE is performed using a photoresist mask R6 so as to selectively etch the substrate 30, thus forming the through-hole 30a whose bottom reaches the first insulating film 500. Then, the photoresist mask R6 is removed.

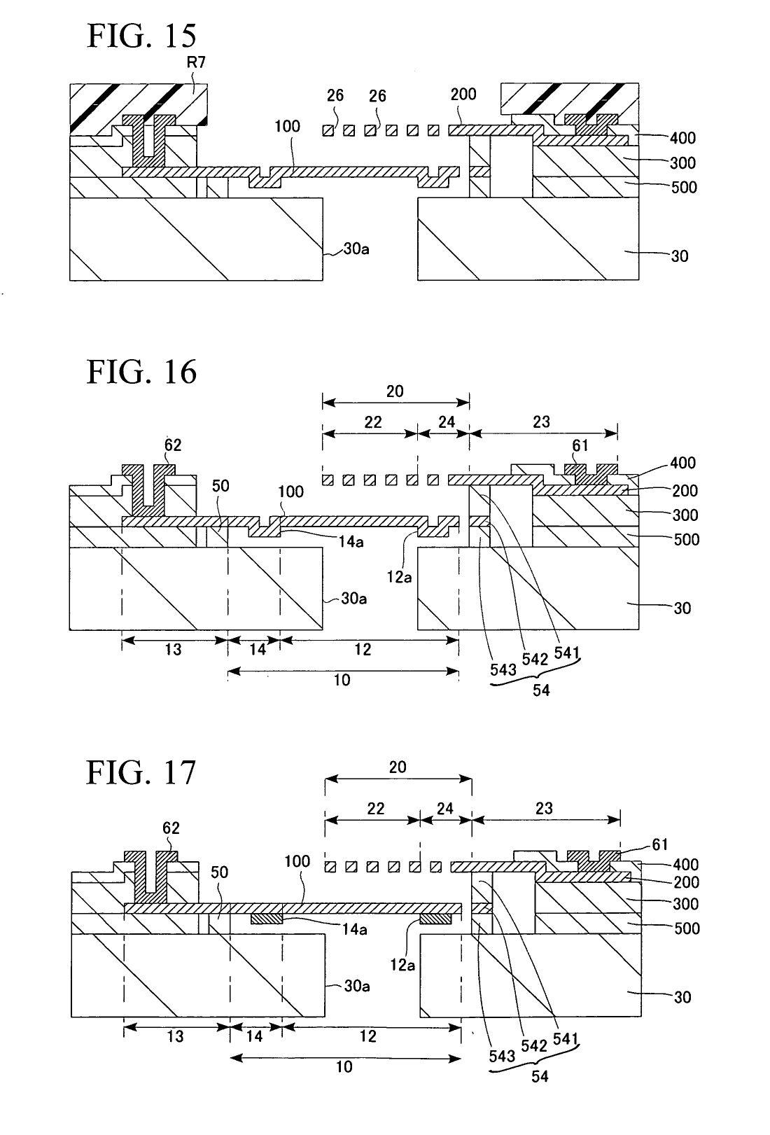

In a twelfth step of the manufacturing method shown in FIG. 15, wet etching using buffered hydrofluoric acid (buffered HF) is performed using a photoresist mask R7 so as to selectively etch and remove the third insulating film 400, the second insulating film 300, and the first insulating film 500. The holes 26 formed in the second conductive film 200 supply an etchant to the prescribed gap formed between the second conductive film 200 and the first conductive film 100. Numerous holes (corresponding to the holes 16 of the arms 14 of the diaphragm 10) formed in the first conductive film 100 supply an etchant to the prescribed gap between the first conductive film 100 and the substrate 30. The through-hole 30a of the substrate 30 supplies an etchant to the first insulating film 500. When all the third insulating film 400, the second insulating film 300, and the first insulating film 500 are composed of the same material, they can be sequentially removed in this step.

In a thirteenth step of the manufacturing method shown in FIG. 16, the photoresist mask R7 is removed; then, dicing is performed; thus, it is possible to complete the production of a die having the MEMS structure of the condenser microphone as shown in FIG. 16.

### 3. Variations

The present invention can be modified in a variety of ways; hence, variations will be described in detail.
(1) First Variation

FIG. 17 shows a first variation of the condenser microphone, wherein the projections 12a and 14a (which project from the backside of the diaphragm 10 towards the substrate 30) are formed using an insulating film 101 joining the first conductive film 100. In order to form the projections 12a and 14a by use of the insulating film 101, before the second step shown in FIG. 5, the recesses 500a and 500b of the first insulating film 500 are embedded with the insulating film 101; then, the surface portions of the insulating film 101 are removed by way of at least one of cutting and polishing. In this connection, a silicon nitride film (which can be removed independently of the first insulating film 500) can be selected for the insulating film 101.
(2) Second Variation

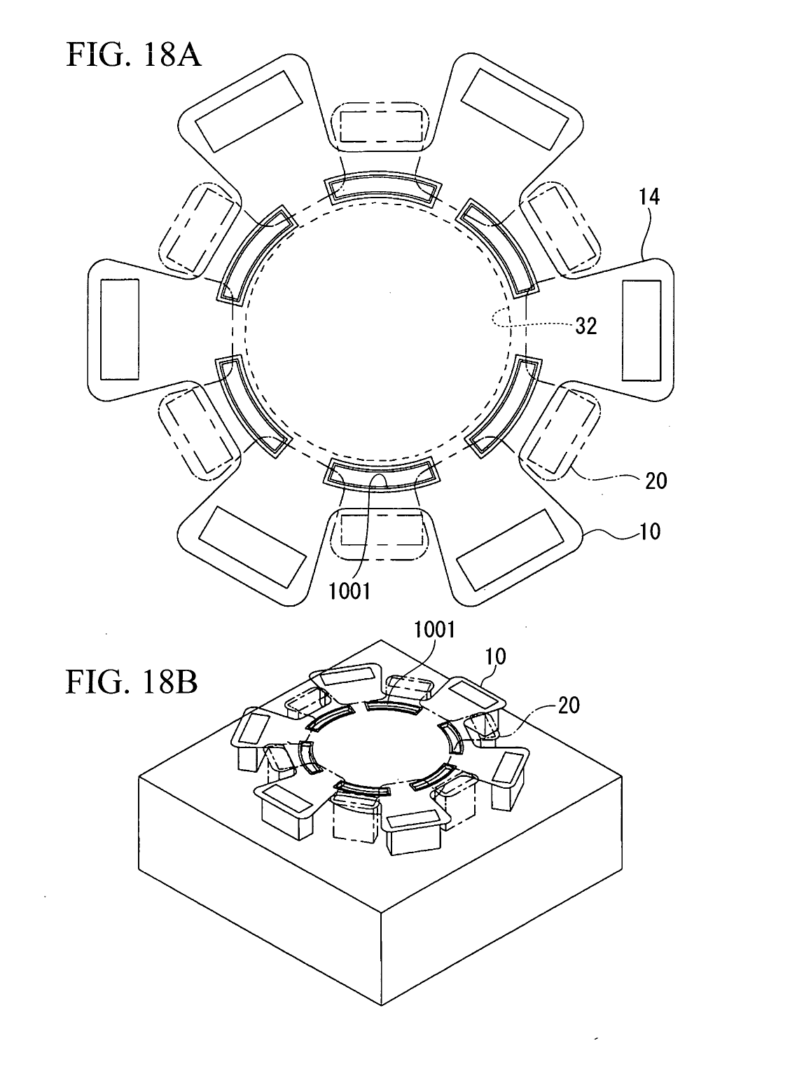

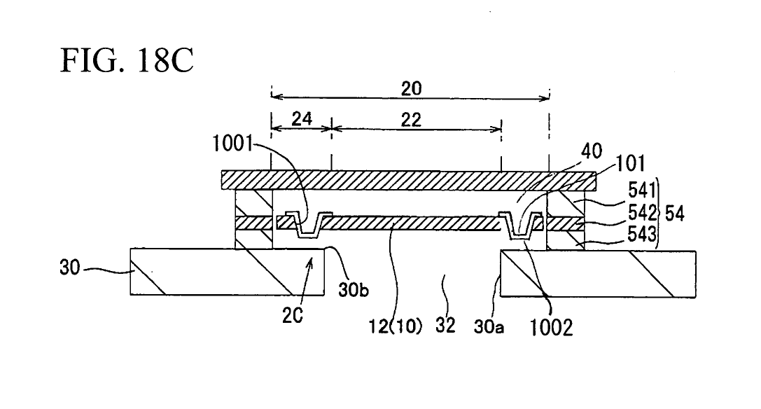

A second variation of the condenser microphone will be described with reference to FIGS. 18A to 18C.

In the second variation, the projections 12a (which project from the diaphragm 10 towards the substrate 30) are each formed using the insulating film 101, which is embedded between a plurality of slits 1001 formed in the first conductive film 100. For the sake of convenience, FIGS. 18A to 18C do not show etching holes formed in the diaphragm 10 and the plate 20, wherein the plate 20 is drawn using dashed lines.

Next, the formation of projections 1002 using the insulating film 101 will be described in detail. After the second step of the manufacturing method shown in FIG. 5, the first conductive film 100 is etched so as to expose the recessed 500a (which are formed in the first step shown in FIG. 4), thus forming the slits 1001 above the first conductive film 100. After completion of etching, the insulating film (composed of a silicon nitride film) 101 is formed on the first conductive film 100 and is embedded in the slits 1001 and the recesses 500a. Then, the insulating film 101 is etched so as to form the projections 12a. It is preferable that the outlines of the projections 1002 (which are formed by etching) be slightly larger than the outlines of the slits 1001 (formed on the first conductive film 100) in plan view. Thus, it is possible to improve the adhesion between the first conductive film 100 and the insulating film 101. Since the second variation designed such that the areas between the slits 1001 (formed in the first conductive film 100) are embedded with the insulating film 101, it is possible to appropriately adjust the internal stress occurring on the diaphragm 10.

The aforementioned manufacturing method adapted to the second variation describes such that the recesses 500a are formed by etching before the formation of the first conductive film 100. Instead, it is possible to form the recesses 500a after the formation of the first conductive film 100. In this case, it is possible to form the recesses 500a by use of a mask which is used to form the slits 1001.

In the second variation shown in FIGS. 18A to 18C, the projections 1002 (which are formed using the insulating film 101) are positioned in the areas between the arms 14 of the diaphragm 10 adjoining together. Similar to the projections 14a of the arms 14 (see FIG. 2B), the projections 1002 can be formed and positioned in the arms 14 of the diaphragm 10. Alternatively, the multiple projections 1002 can be interconnected together in a circumferential manner; that is, it is possible to form only a single projection 1002 having a circular shape.
(3) Third Variation

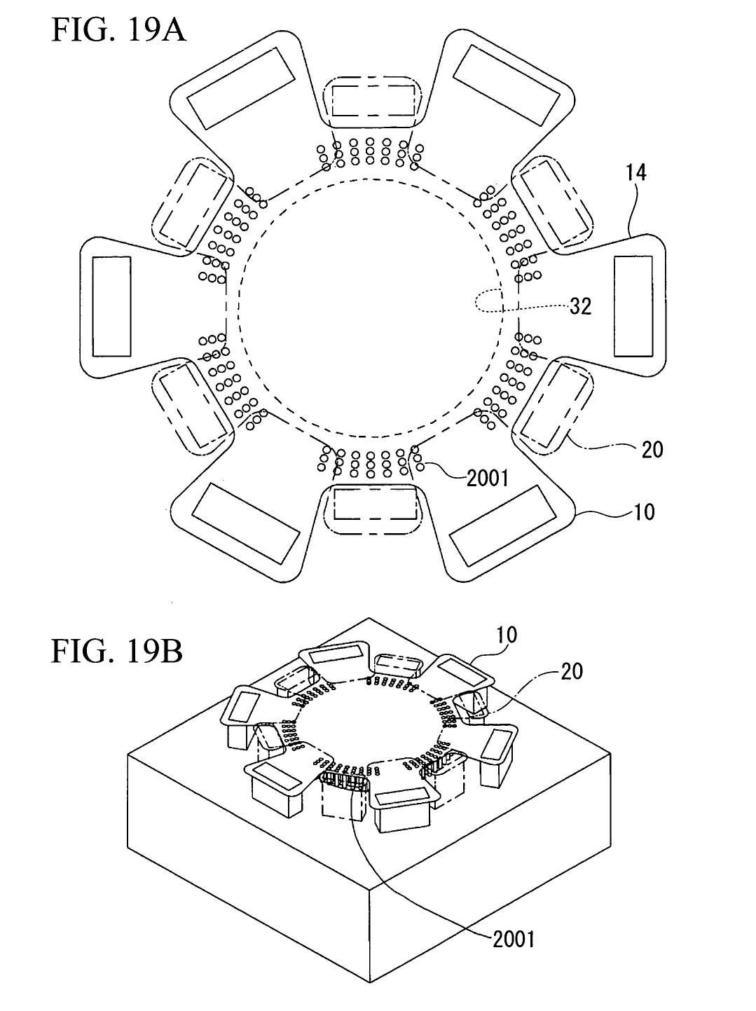

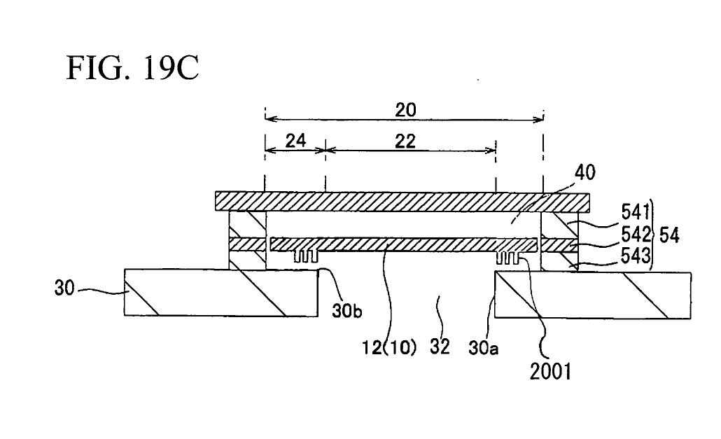

Next, a third variation of the condenser microphone will be described with reference to FIGS. 19A to 19C. In the third variation, a plurality of diaphragm projections 2001 (which project from the diaphragm 10 towards the substrate 30) is formed using the insulating film 101 above the first conductive film 100. For the sake of convenience, FIGS. 19A and 19B do not show etching holes formed in the diaphragm 10 and the plate 20, wherein the plate 20 is drawn using dashed lines.

The diaphragm projections 2001 are formed using the insulating film 101 (composed of a silicon nitride film), wherein they project downwardly from the diaphragm 10. In the third variation shown in FIGS. 19A to 19C, the three sets of the diaphragm projections 2001 (each formed in a circular rod-like shape) are aligned in a circumferential direction and are also aligned in series in a radial direction. Hence, the diaphragm projections 2001 block sound waves (which enter into the areas between the arms 14 of the diaphragm 10) from entering into the back cavity 32. Since the diaphragm projections 2001 are each formed in the circular rod-like shape by use of the insulating film 101, it is possible to reliably prevent the diaphragm 10 from being unexpectedly attached to the substrate 30.

The diaphragm projections 2001 are not necessarily limited in the aforementioned shape and positioning; hence, they can be alternately positioned in the circumferential direction; alternatively, they can be positioned in the arms 14 of the diaphragm 10.
(4) Fourth Variation

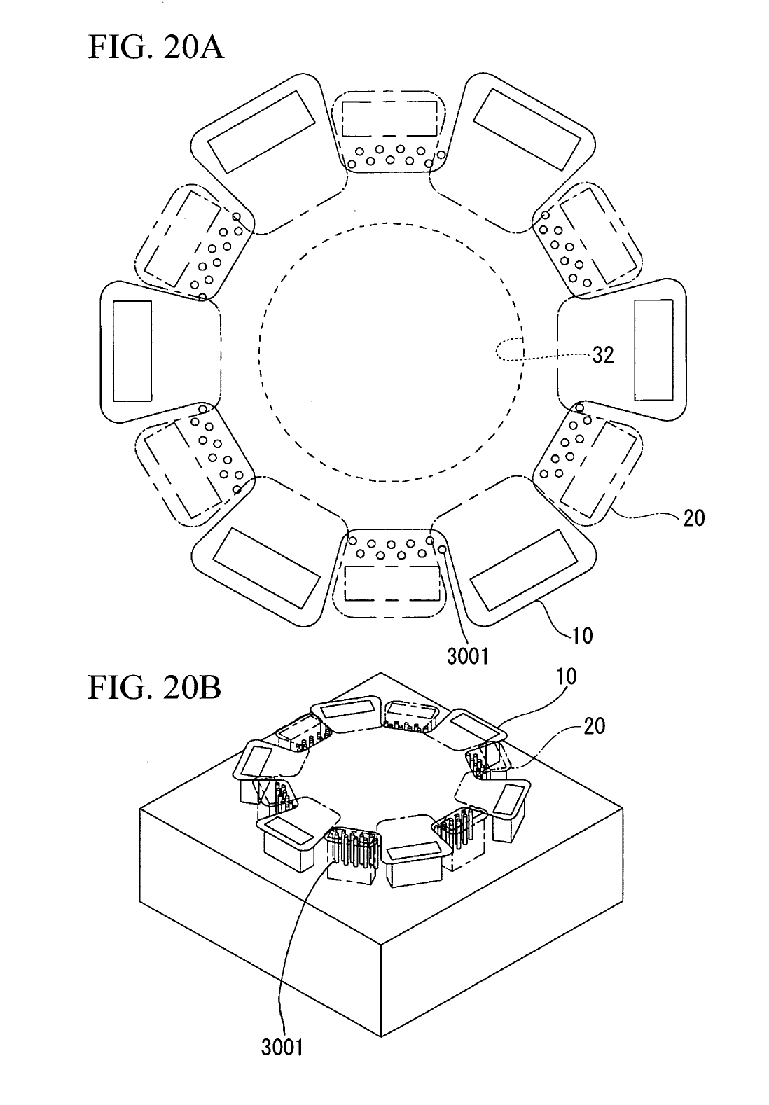

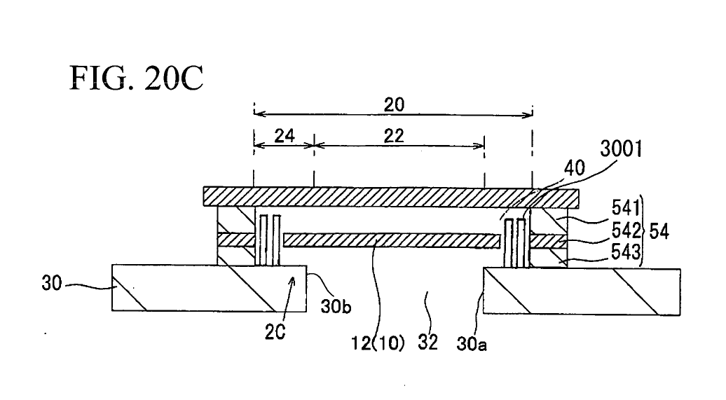

Next, a fourth variation of the condenser microphone will be described with reference to FIGS. 20A to 20C. A plurality of substrate projections 3001 is formed using the insulating film 101 and is directed from the substrate 30 towards the arms 24 of the plate 20, so that the acoustic resistance formed between the diaphragm 10 and the substrate 30 is positioned in the periphery of the areas between the arms 14 of the diaphragm 10. For the sake of convenience, FIGS. 20A to 20C do not show etching holes, wherein the plate 20 is drawn using dashed lines.

In the fourth variation shown in FIGS. 20A to 20C, the substrate projections 3001 are each formed in a rod-like shape by use of the insulating film 101 (composed of a silicon nitride film), wherein they are aligned along the external periphery of the areas between the arms 14 of the diaphragm 10. Specifically, the two set of the substrate projections 3001 are aligned in the circumferential direction and are positioned alternately in the radial direction. The substrate projections 3001 reliably block sound waves from entering into the areas between the arms 14 of the diaphragm 10. When the plate 20 is unexpectedly deflected or curved due to an impact with something, the distal ends of the substrate projections 3001 come in contact with the plate 20 before the plate 20 comes in contact with the diaphragm 10; hence, it is possible to reliably prevent the plate 20 from accidentally coming in contact with the diaphragm 10.
(5) Fifth Variation

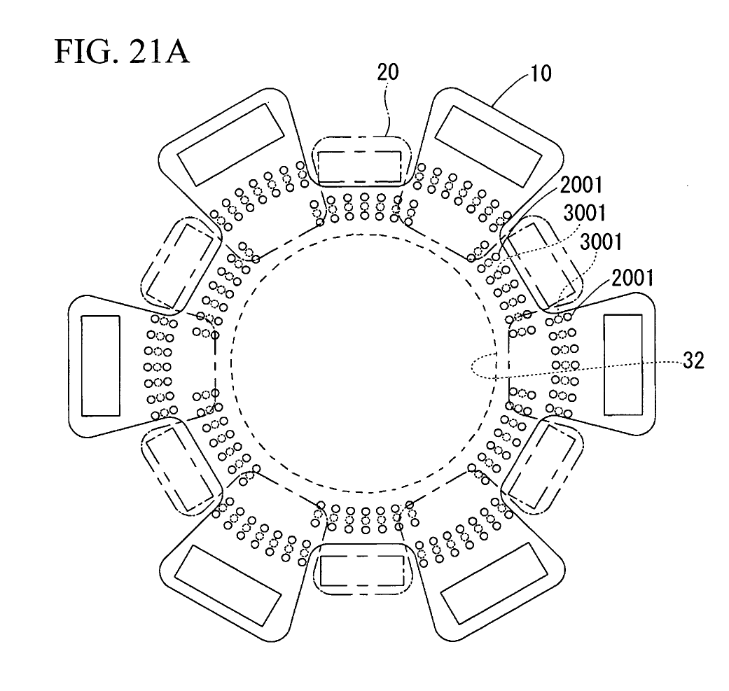

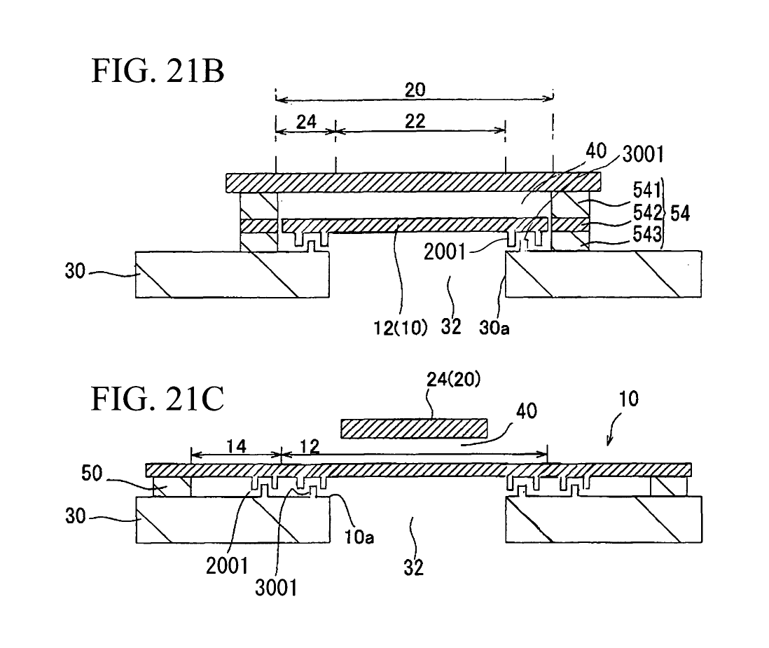

Next, a fifth variation of the condenser microphone will be described with reference to FIGS. 21A to 21C.

The acoustic resistance is formed between the diaphragm 10 and the substrate 30 by use of a plurality of diaphragm projections 2001 which is formed using the insulating film 101 and is directed from the diaphragm 10 (corresponding to the first conductive film 100) towards the substrate 30 and a plurality of substrate projections 3001 which is formed using the insulating film 101 and is directed from the substrate 30 towards the areas between the arms 14 of the diaphragm 10. For the sake of convenience, FIG. 21A to 21C do not show etching holes formed in the diaphragm 10 and the plate 20, wherein the plate 20 is drawn using dashed lines. In FIG. 21A, the diaphragm projections 2001 are indicated by small circles, while the substrate projections 3001 are indicated by small dotted circles.

Both the diaphragm projections 2001 and the substrate projections 3001 are formed using the insulating film 101 (composed of a silicon nitride film) and are each formed in a rod-like shape. They are positioned in the areas between the arms 14 of the diaphragm 10 as well as in the arms 14 of the diaphragm 10. Specifically, the two sets of the diaphragm projections 2001, which project downwardly from the diaphragm 10, are positioned in the circumferential direction, while one set of the substrate projections 3001, which project upwardly from the substrate 30 towards the diaphragm 10, is positioned between the two sets of the diaphragm projections 2001, wherein all the diaphragm projections 2001 and the substrate projections 3001 are aligned in series in the radial direction. That is, the diaphragm projections 2001 and the substrate projections 3001 are positioned alternately in the arms 14 of the diaphragm 10 as well as in the areas between the arms 14 of the diaphragm 10.

Thus, the acoustic resistance is formed between the diaphragm 10 and the substrate 30 by means of the diaphragm projections 2001 and the substrate projections 3001, whereby it is possible to prevent the diaphragm 10 from being unexpectedly attached to the substrate 30 even when they become positioned in contact with each other due to an impact with something. When the diaphragm 10 vibrates due to sound waves, the diaphragm projections 2001 (which are positioned in the periphery of the diaphragm 10) come in contact with the substrate projections 3001, whereby it is possible to prevent the diaphragm from being accidentally deformed in shape even when the periphery of the diaphragm 10 does not follow up the “vibrating” center portion. Since the fifth variation is designed to prevent the diaphragm 10 from being accidentally deformed in shape, it is possible to precisely detect capacitance variations of the condenser due to pressure variations; hence, it is possible to improve the sensitivity of the condenser microphone.

The present invention is not necessarily limited to the embodiment and variations, which can be further modified in a variety of ways within the scope of the invention defined by the appended claims.

For example, the structures, the manufacturing processes, and the materials described in conjunction with the present embodiment are merely illustrative and not restrictive. Of course, the present description does not include the full context of this technology; hence, well-known factors of this technology are omitted for the sake of simplification of the description. Specifically, in the manufacturing method, it is possible to appropriately select other compositions of films, other deposition methods of films, and other patterning methods as well as other physical combinations of films forming condenser microphones, other values of thicknesses of films, other outlines of films, and the like.

What is claimed is:

1. A condenser microphone comprising:
a substrate having an opening in a back cavity;
a diaphragm composed of a deposited film having a conductive property, wherein the diaphragm includes a center portion positioned opposite the opening and its surrounding area of the substrate and a plurality of arms extended in radial directions from the center portion;
a plate composed of a deposited film having a conductive property, which is positioned opposite the diaphragm; and
a support structure for supporting a periphery of the diaphragm and a periphery of the plate above the substrate while insulating the diaphragm and the plate from each other, wherein the support structure composed of a deposited film forms a first gap between the substrate and the diaphragm and a second gap between the diaphragm and the plate,
wherein a plurality of projections that project towards the substrate is formed in the center portion of the diaphragm in a circumferential direction between the plurality of arms.

2. A condenser microphone according to claim 1, wherein the plurality of projections has an insulating property.

3. A condenser microphone according to claim 1, wherein the diaphragm is composed of the deposited film having a conductive property, wherein the plate is composed of the deposited film having a conductive property, and wherein a distance between a center and a peripheral end of the plate is shorter than a distance between a center of the center portion and a distal end of the arm of the diaphragm.

4. A condenser microphone according to claim 1, wherein the plurality of projections is formed in the center portion and the plurality of arms of the diaphragm, wherein the plurality of projections formed in the center portion is positioned alternately with the plurality of projections formed in the plurality of arms in a radial direction, wherein the plurality of projections is formed to traverse across the plurality of arms, and wherein opposite ends of each projection formed in the center portion are positioned opposite the projections formed in the adjacent arms in the radial direction.

5. A condenser microphone according to claim 4, wherein the plurality of projections formed in the plurality of arms is formed using a waviness of the diaphragm in the radial direction.

6. A condenser microphone according to claim 1, wherein a plurality of holes is formed in the plurality of arms.

7. A condenser microphone according to claim 1, wherein a plurality of cutouts is formed in a peripheral portion of the plate and is positioned opposite the plurality of arms of the diaphragm.

8. A condenser microphone according to claim 1, wherein the support structure includes a plurality of first supports, each having an insulating property, for supporting the periphery of the diaphragm above the substrate and a plurality of second supports, each having an insulating property, for supporting the periphery of the plate above the substrate.

9. A condenser microphone according to claim 8, wherein each of the second supports includes an upper insulating portion and a lower insulating portion as well as a guard electrode sandwiched between the upper insulating portion and the lower insulating portion.
